(19) United States
(12) Patent Application Publication
(10) Pub. No.: US 2021/0115976 A1
(43) Pub. Date: Apr. 22, 2021

(54) CLAMPING DEVICE

(71) Applicant: SEW-EURODRIVE GMBH & CO. KG, Bruchsal (DE)

(72) Inventors: Sascha HALLER, Karlsruhe (DE); Jens SCHILLINGER, Rastatt (DE)

(73) Assignee: SEW-EURODRIVE GMBH & CO. KG, Bruchsal (DE)

(21) Appl. No.: 17/257,681

(22) PCT Filed: Jun. 26, 2019
(86) PCT No.: PCT/EP2019/025200

§ 371 Date: Jan. 4, 2021

(30) Foreign Application Priority Data
Jul. 3, 2018 (DE) 10 2018 005 225.8

(51) Int. Cl. F16D 1/08

(52) U.S. Cl. CPC F16D 1/0864; F16B 2/065; F16D 1/0847

(57) ABSTRACT

A clamping connection includes a hollow shaft region, a shaft at least partially introduced into the hollow shaft region, a screw, and a clamping ring. The hollow shaft region has an axial slot radially extending through the hollow shaft region. The screw has a screw thread and a screw head, which is larger than the largest diameter of the screw thread. The hollow shaft region has a flattening, the screw rests at least partially against the flattening, and the screw is set apart from the shaft.

### FIELD OF THE INVENTION

The present invention relates to a clamping device.

### BACKGROUND INFORMATION

German Patent Document Nos. 10 2005 031 839 and 10 2005 031 839 describe a clamping connection between a shaft and a hollow shaft.

German Patent Document No. 10 2011 013 887 describes a clamp coupling for the torsionally fixed connection of two rotating parts, preferably a shaft and hub.

German Patent Document No. 10 2016 221 310 describes a clamp coupling.

### SUMMARY

Example embodiments of the present invention provide clamping connection for a drive in which high dynamics of the drive may be achieved.

According to an example embodiment of the invention, a clamping connection includes a hollow shaft region, a shaft which is at least partially introduced into the hollow shaft region, a screw, in particular a clamping screw, and a clamping ring. The hollow shaft region has an axial slot, e.g., an axial slot which extends radially through the hollow shaft region, and the screw has a screw thread and a screw head, e.g., the screw head has the largest diameter, which is larger than the largest diameter of the screw thread. The hollow shaft region has a flattening, e.g., a region which has a reduced radial wall thickness in comparison with the radial wall thickness outside the region and/or which has a reduced outer radius in comparison with the wall thickness outside the region. The screw rests at least partially against the flattening, e.g., by its screw thread, the screw being set apart from the shaft, e.g., from the envelope surface of the shaft.

This has the advantage that the screw prevents the clamping ring from rotating with the aid of the flattening. This is because the screw rests against the flattening, that is to say, against a radial depression. In addition, the screw is accommodated in bores of the clamping ring and thus is positively connected to the clamping ring.

The clamping connection connects the shaft to the hollow shaft region in a friction-locked manner, e.g., a rotor shaft to an adapter shaft, which drives an inputting toothed part of a gear unit. The greatest possible dynamic response of the drive may be achieved because the clamping connection has a low mass and a low moment of inertia.

According to example embodiments, the clamping connection has a set screw for axially locking the clamping ring on the hollow shaft region, the set screw being connected by screws in a radially directed threaded bore. This has the advantage that the set screw is screwed into the threaded bore and thus can be pressed against the hollow shaft region so that the axial locking of the clamping ring is able to be ensured with the aid of the set screw.

According to example embodiments, the region covered by the flattening in the circumferential direction, e.g., the circumferential angle region, includes the circumferential angle region covered by the axial slot or at least overlaps with it, e.g., the axial region covered by the axial slot includes the axial region covered by the flattening or at least overlaps with it. This offers the advantage that the stability of the hollow-shaft section is only negligibly reduced by the flattening because it is situated in the region of the slot.

According to example embodiments, a recess is situated on the clamping ring, e.g., for balancing purposes, which is set apart from the set screw and from the screw in the circumferential direction. This is considered advantageous insofar as an imbalance is able to be reduced or avoided.

According to example embodiments, the screw head rests against a contact area of the clamping ring, e.g., against a planar surface region of the clamping ring, and the radial outer contour or the radially outer edge of the clamping ring touches the contact area in a linear fashion or at least at multiple points. This has the advantage that as little mass as possible is situated in the radially outer region. This is because the outer region contributes a very large share to the moment of inertia of the clamping ring. Minimizing this outer region therefore makes it possible to achieve a low moment of inertia.

According to example embodiments, the screw head rests against a contact area of the clamping ring, e.g., against a planar surface region of the clamping ring, the axial extension of the largest radial clearance of the clamping ring touching the extension of the largest radial clearance of the contact area in a line-type fashion or at least at multiple axial positions.

The clamping connection connects the shaft to the hollow shaft region in a friction-locked manner, e.g., a rotor shaft to an adapter shaft, which drives an inputting toothed part of a gear unit. The greatest possible dynamic response of the drive may be achieved because the clamping connection has a low mass and a low moment of inertia. The outer contour of the clamping ring thus is selected so that the outer contour of the contact area provides the shape. The radially outer contour of the contact area thus defines the radially outer shape of the body of revolution.

According to example embodiments, a clearance of less than two-tenths or five-tenths of a millimeter counts as contact. This offers the advantage that production and safety tolerances are taken into account. As a result, the particular mass reduction and moment of inertia reduction still able to be produced and ensuring safety are achievable.

According to example embodiments, the axial extension of the largest radial clearance of the clamping ring has a constant region which is adjoined on both sides by a rounded region, e.g., a circular segment, on whose side facing away from the constant region a linear region follows, e.g., a region in which the largest radial clearance extends proportionally to the axial position. This is considered advantageous insofar as it allows for an uncomplicated production because the contour regions with constant, linear or circular extensions are readily programmable in the particular tool machine that may be used to produce the clamping ring, e.g., used for performing the finish machining.

According to example embodiments, the clamping ring is a body of revolution whose radially outer surface is predefined by the axial extension of the largest radial clearance, the body of revolution having recesses. This is considered advantageous insofar as it allows for a simple production of the body of revolution. An imbalance is therefore also able to be avoided.

According to example embodiments, the clamping ring has a radially and axially uninterrupted slot, and the screw thread is at least partially screwed into a threaded bore situated on the side of the slot of the clamping ring facing away from the contact area. This offers the advantage that the contact area supporting the screw head is situated on the first side of the slot, and the threaded bore into which the screw thread is screwed is situated on the other side of the slot. The contact area is planar and, e.g., parallel to the slot, e.g., to the slot plane.

According to an example embodiment of the present invention, a drive includes a clamping connection, the shaft is a rotor shaft of an electric motor, and the hollow-shaft section is connected in a torsionally fixed manner to the inputting toothed part of a gear unit driven by the electric motor.

This offers the advantage that the hollow-shaft section is a shaft region of an adapter shaft, the associated adapter being situated between the electric motor and the gear unit, and being connected in a torsionally fixed manner to the inputting toothed part, e.g., pinion, of the gear unit.

According to example embodiments, the moment of inertia of the clamping ring is slow. As a result, the drive is operable with high dynamics.

Further features and aspects of example embodiments of the present invention are described in greater detail below with reference to the appended schematic Figures.

### BRIEF DESCRIPTION OF THE DRAWINGS

FIGS. 1 through 6 illustrate an exemplary embodiment of to the present invention.

FIGS. 7 through 20 illustrate an exemplary embodiment of to the present invention.

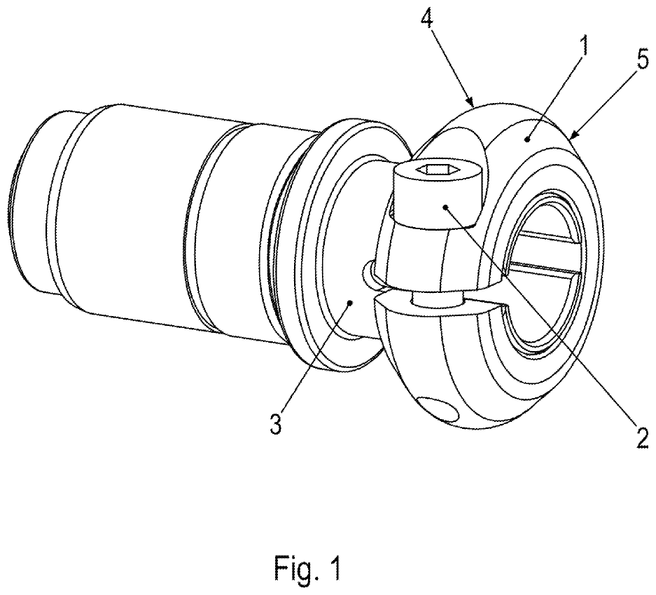

FIG. 1 is a perspective view of a first clamping connection according to an example embodiment of the present invention, in a perspective view in a first viewing direction.

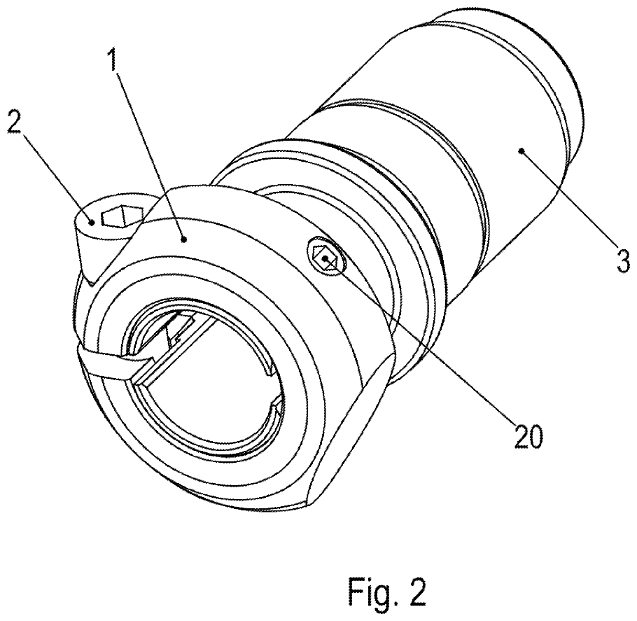

FIG. 2 illustrates the clamping connection from another viewing direction.

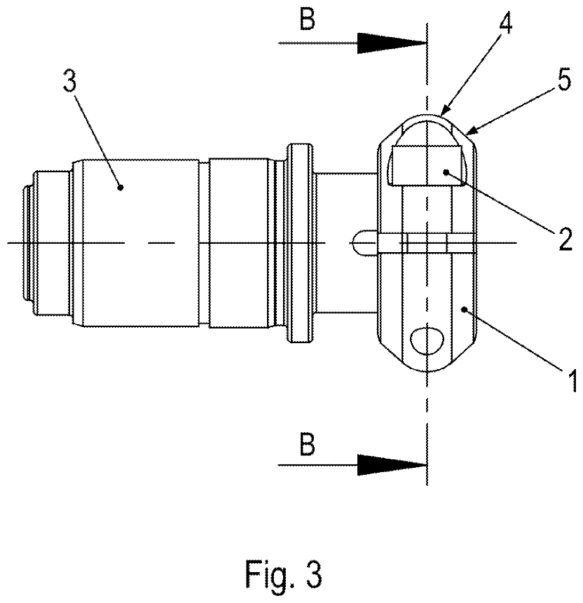

FIG. 3 is a side view of the clamping connection with a viewing direction orthogonal to the screw axis.

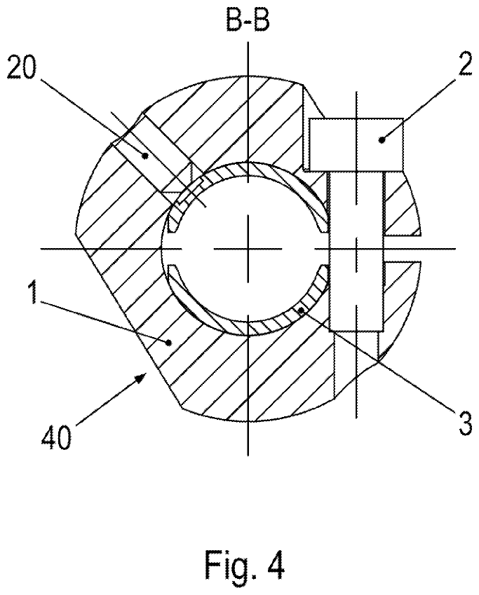

FIG. 4 is an associated cross-sectional view.

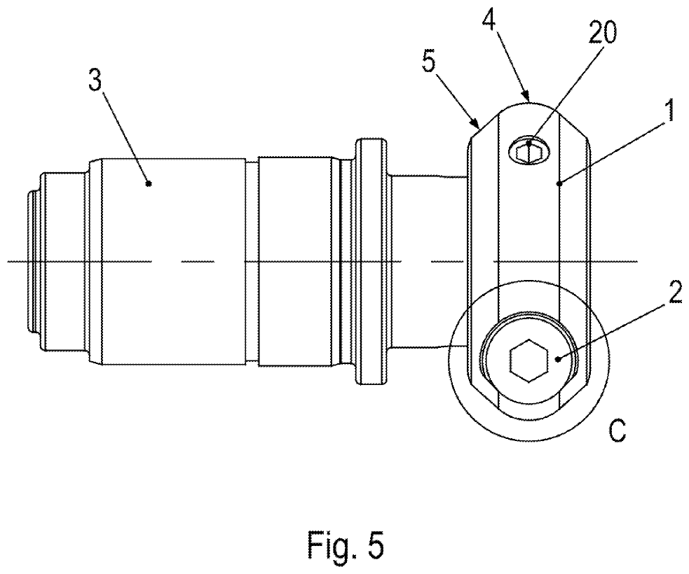

FIG. 5 is a further side view of the clamping connection with a viewing direction parallel to the screw axis.

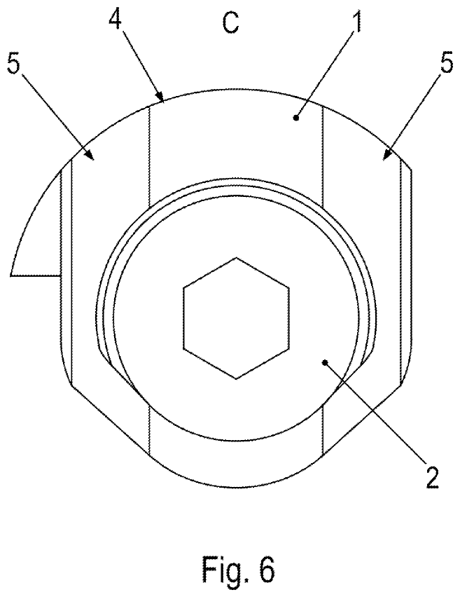

FIG. 6 illustrates an enlarged portion of FIG. 5.

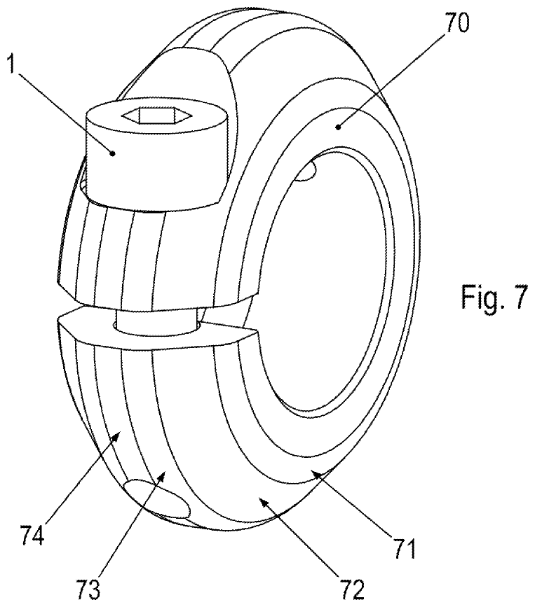

FIG. 7 is a perspective view of a second clamping ring 70.

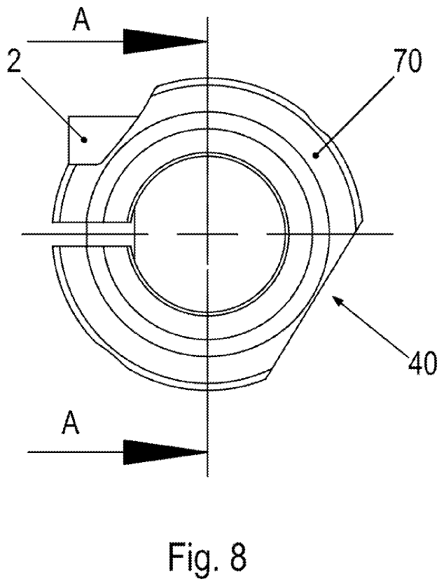

FIG. 8 is an associated side view.

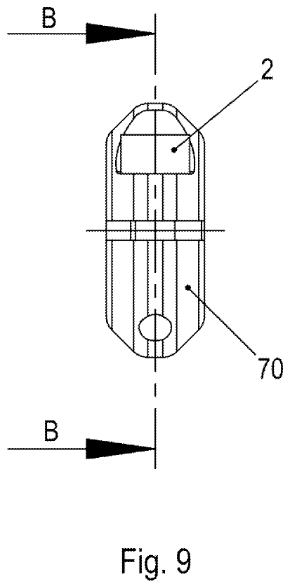

FIG. 9 is an associated front view.

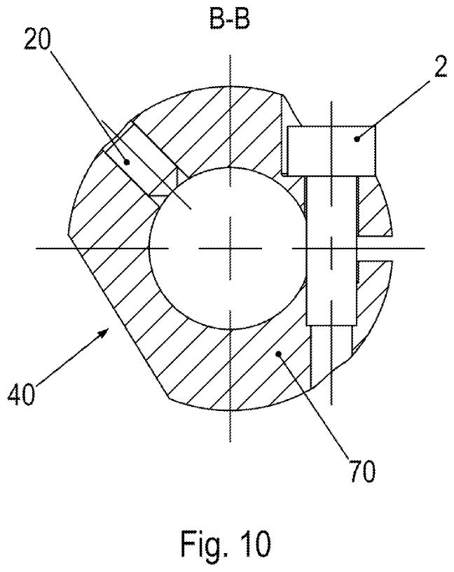

FIG. 10 is a cross-sectional view of clamping ring 70.

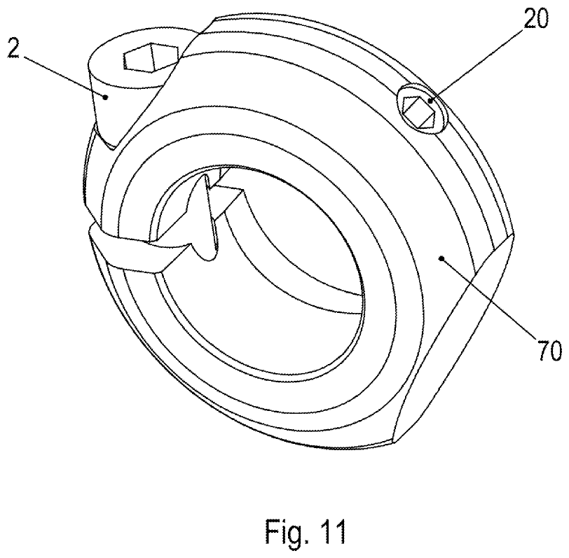

FIG. 11 illustrates clamping ring 70 from another viewing direction.

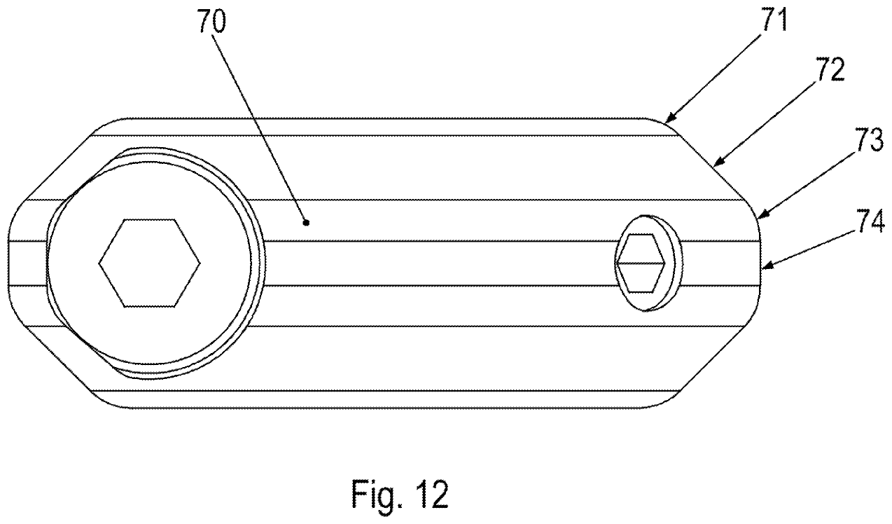

FIG. 12 is a top view of clamping ring 70.

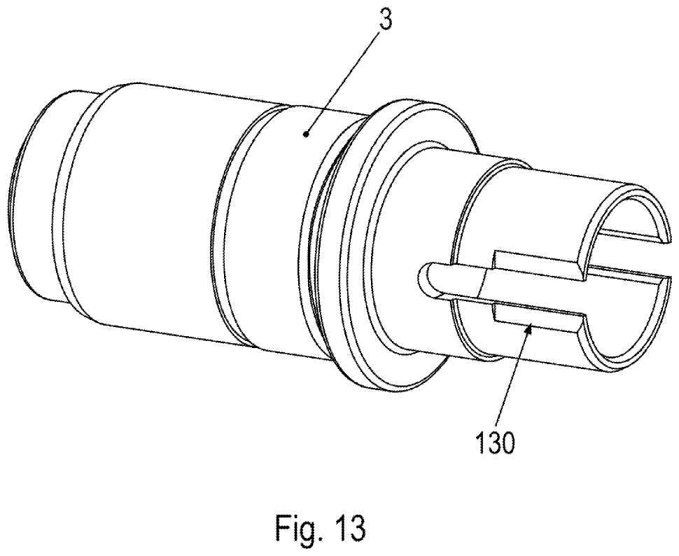

FIG. 13 is a perspective view of an adapter shaft 3.

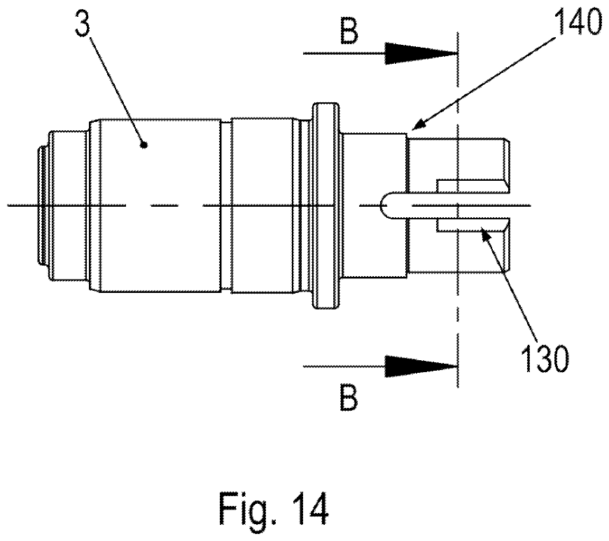

FIG. 14 is an associated side view.

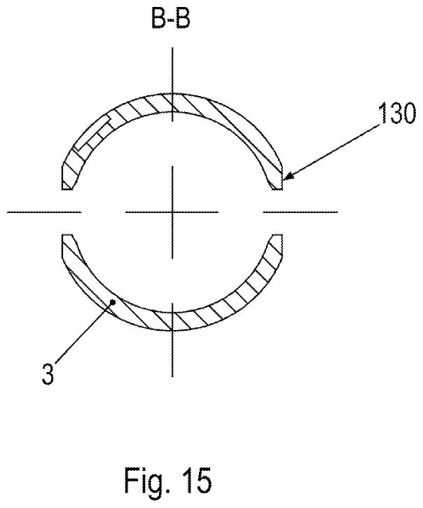

FIG. 15 is a cross-sectional view of adapter shaft 3.

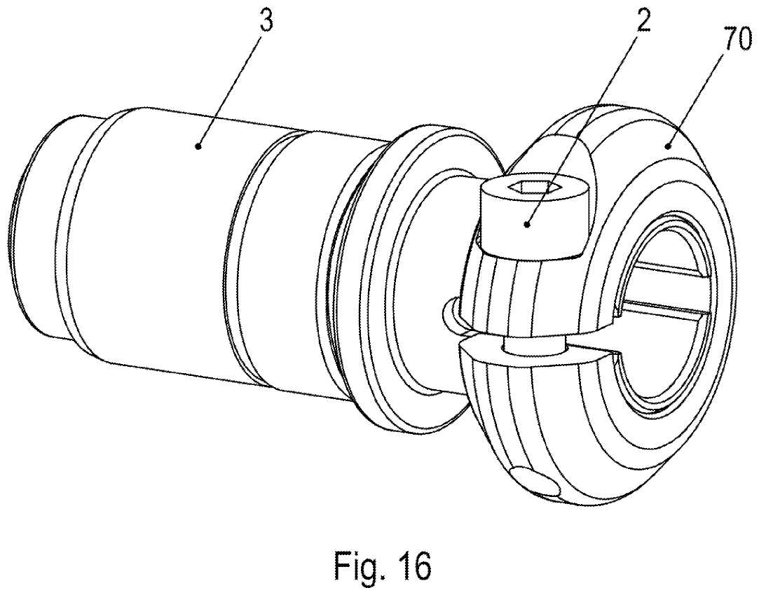

FIG. 16 is a perspective view of the clamping connection.

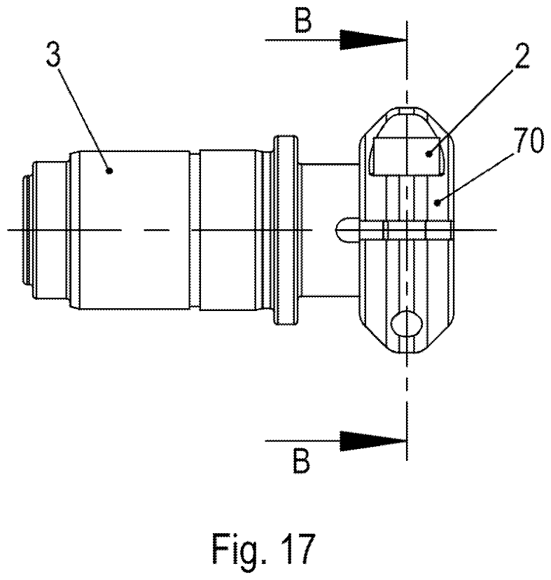

FIG. 17 is an associated side view.

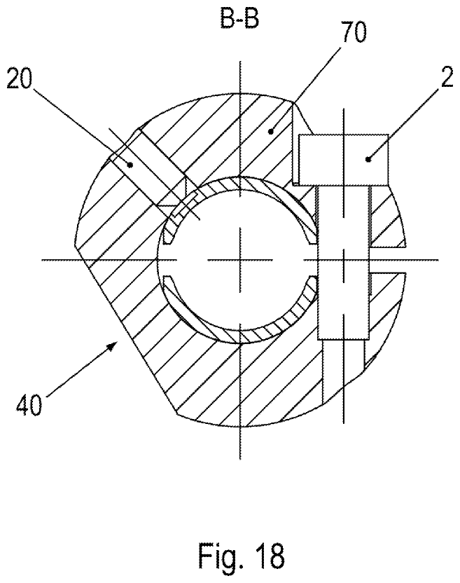

FIG. 18 is an associated cross-sectional view.

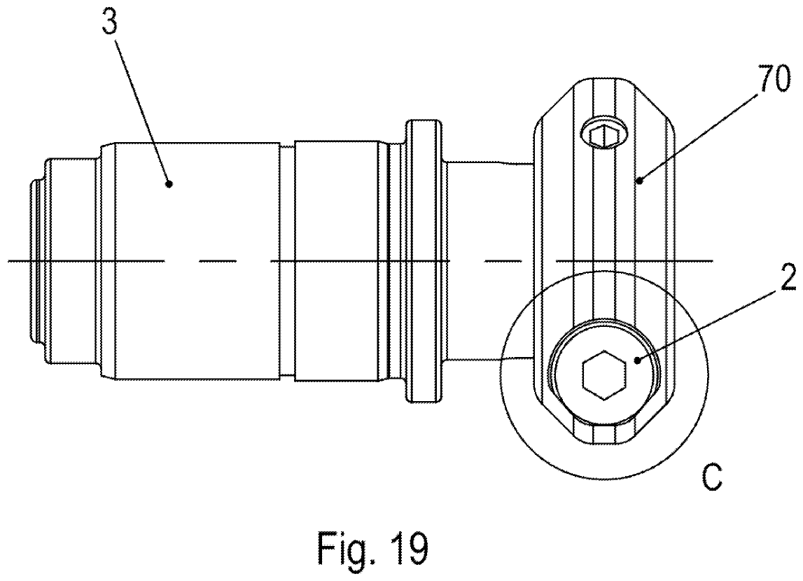

FIG. 19 is a side view from a different viewing direction than FIG. 17.

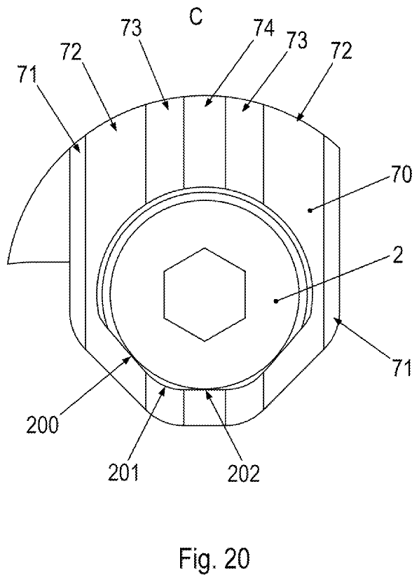

FIG. 20 is an enlarged view.

### DETAILED DESCRIPTION

As schematically illustrated in FIGS. 1 through 6, the clamping connection has an adapter shaft including a hollow-shaft section 3.

Situated in the region of hollow-shaft section 3 are axially directed slots, which lead to the outside, i.e., are open in the outward direction. These slots have a radially uninterrupted configuration. Two slots, for example, are provided, which are situated diametrically opposite each other on the hollow-shaft section.

A clamping ring 1 is slipped over this slotted hollow shaft region 3 of the shaft, e.g., the adapter shaft, in the axial direction.

Clamping ring 1 has on its circumference an axially and radially uninterrupted slot, which has a smaller extension in the circumferential direction than in the radial and/or axial direction.

A screw 2, e.g., a clamping screw, is guided through a bore which perpendicularly protrudes through the slot plane, which means that the screw axis has a tangential alignment at the circumferential position of the slot center.

In the circumferential direction, bores are situated in the clamping ring on both sides, the first bore being introduced into a surface that is aligned in parallel with the slot, e.g., a contact area for the screw head of screw 2.

This first bore terminates in the slot, and the second bore is situated on the side that faces away from the first bore and is arranged as a threaded bore.

The screw thread of screw 2 is screwed into this threaded bore so that the screw head exerts pressure on the contact area and clamping ring 1 is clampable in this manner, e.g., shrinkable, onto hollow-shaft section 3.

A shaft is at least partially inserted into hollow-shaft section 3. This shaft thus covers an axial region which encompasses the axial region covered by clamping ring 1.

By operating screw 2, i.e., by screwing it into the threaded bore, hollow-shaft section 3 is thus connectable to the shaft in a friction-locked manner.

The ring cross-section of clamping ring 1 is not rectangular but arranged in a rounded shape on its outer side. Of the imaginary rectangular cross-section, material is thus removed starting from the largest diameter of this imaginary ring, so that a rounded region 4 and an adjoining chamfer 5, e.g., a straight and/or linear chamfer 5, form the outer surface.

As illustrated in FIG. 4, the circle that is part of the largest outer diameter on the surface of clamping ring 1 touches the outer edge of the contact area.

As illustrated in FIGS. 5 and 6, rounded region 4 touches a circular segment of the contact area. This is particularly clear from the lower region of FIG. 6. In the same manner, chamfers 5 are placed directly against the circular contact area.

Overall, the radially outer contour of clamping ring 1 thus is selected so that the contact area is touched at its outer edge and this edge is circular in accordance with the diameter of the screw head of screw 2.

The cylindrically shaped screw head thus rests on the contact area via its lower edge. Rounded region 4 and chamfer 5 therefore touch this outermost edge of the contact area still touched by the lower edge of the screw head.

In the practical execution of the clamping ring, an over-allowance is also provided so that rounded region 4 and/or chamfer 5 has/have a clearance from the lower edge of the screw head of between one-tenth and five-tenths of a millimeter. In other words, the contact area is arranged to be slightly larger so that a safety margin is also provided, in particular to protect against a fracture.

Rounded region 4 may be arranged approximately as a section of a modified torus having an elliptical ring cross-section. Chamfers 5 adjoin axially on both sides. These chamfers may have a linear configuration and thus are arranged as a truncated circular cone in each case.

The two truncated circular cones are connected to the section of the modified torus in a stepless and/or differentiable, manner, i.e., smoothly adjoining, for example. The clamping ring is arranged in symmetry with the particular plane that has the largest outer diameter of the clamping ring, and thus extends through the axial center of the clamping ring, for example. The axial direction is parallel to the normal direction of this plane.

As illustrated in FIG. 4, a set screw 20 is screwed into a radially directed, radially uninterrupted threaded bore, set screw 20 exerting pressure on hollow shaft region 3. Axial locking is achieved in this manner.

Screw 2 rests against a flattening 130 of hollow shaft region 3 adjacent to the slot of hollow shaft region 3.

Hollow shaft region 3, which is illustrated in greater detail also in FIGS. 13 and 14, of the exemplary embodiments has the same design because the same shaft is used in each case.

As illustrated in FIGS. 13 and 14, hollow-shaft section 3 has a non-constant wall thickness in the circumferential angle region covered by flattening 130 in the circumferential direction, so that screw 2, as illustrated in FIG. 4, penetrates the region radially covered by hollow-shaft section 3 because screw 2 rests tangentially against the flattening, i.e., against hollow shaft region 3.

In this manner, screw 2 ensures that clamping ring 1 is locked against rotation in the circumferential direction by screw 2 at flattening 130 of hollow-shaft section 3.

Flattening 130 is provided up to the end of the slot, i.e., toward the axial end of hollow-shaft section 3. Clamping ring 1 together with screw 2 is therefore able to be slipped onto hollow-shaft section 3 during the production. Screw 2 is screwed in further only after the clamping ring has been slipped on in order to produce a friction-locked connection.

As illustrated in FIGS. 13 through 15, slot 130 of hollow shaft region 3 is axially longer than flattening 130. The region axially covered by flattening 130 is thus included by the axial region covered by the slot in the axial direction or is encompassed by it.

Hollow shaft region 3 has a step as an axial stop for clamping ring 1 against which clamping ring 3 rests with its side surface. FIG. 14 illustrates this step.

Situated diametrically across from screw 2 is a region having reduced material, i.e., recess 40, so that clamping ring 2 together with screw 2 has the smallest imbalance possible, and thus is balanced, for example.

Set screw 20 for the axial locking is set apart in the circumferential direction from the circumferential angle region covered by screw 2, e.g., set apart by more than 70°.

Set screw 20 for the axial locking is set apart in the circumferential direction from the circumferential angle range covered by recess 40, e.g., set apart by more than 30°.

In the exemplary embodiment illustrated in FIGS. 16 through 20, clamping ring 70 has a different shape than clamping ring 1 of the above-described exemplary embodiment. The shaft according to FIGS. 13 through 15 is used in the same manner in both exemplary embodiments.

As illustrated in FIG. 16 and FIG. 20, clamping ring 70 has a planar extension 74 in the center, i.e., in the area of the symmetry plane, and thus has a hollow-cylindrical configuration. Axially adjoining on both sides then is a rounded form 73, i.e., for example, an annulus sector, which is followed by another straight chamfer 72, i.e., a truncated circular cone.

A further rounded region 71 follows in the axially outward direction, i.e., another annulus sector.

Although these regions come very close to the contact area of the screw head, clearances are provided here. Only a tangential contact region 202 exists in planar extension 74.

A tangential contact area 200 also exists between chamfer 72 and the contact area of the screw head.

However, a clearly noticeable protrusion 201 can be seen between rounded region 73 and the contact area.

An advantage in the production of the example embodiment illustrated in FIGS. 16 to 20 is the uncomplicated production because only circle radii and straight chamfers are required but no complicated free forms.

According to example embodiments of the present invention, the clamping connection is therefore implemented with the aid of a clamping ring and screw, the screw head of the screw resting on a planar contact area on the clamping ring. The radial outer contour of the clamping ring is selected to be radially as small as possible such that the surface region of the clamping ring defined by the radial outer contour contacts the contact area in a linear fashion or at least at multiple points. Contact is defined only with an accuracy of five-tenths of a millimeter, for example. The screw rests against a flattening of the hollow shaft so that the flattening together with the screw brings about the axial locking of the clamping ring on the hollow shaft.

In further exemplary embodiments, recess 40 is, for example, by one or more axial or radial bore(s) instead of a circle secant-shaped section.

In further exemplary embodiments, instead of the step illustrated in FIG. 14 as an axial stop, the end of the flattening is used as an axial stop for clamping ring 1 when clamping ring 1 is slipped onto hollow shaft region 3 because screw 2 rests against the end of the flattening at this end in the axial direction, i.e., against the region having the increasing wall thickness of hollow-shaft section 3.

### LIST OF REFERENCE NUMERALS

1 clamping ring
2 screw
3 hollow-shaft section, e.g., of an adapter shaft
4 rounded extension
5 straight, e.g., linear, chamfer
20 set screw
40 recess
70 clamping ring
71 rounded extension
72 straight, e.g., linear, chamfer
73 rounded extension
74 planar extension
130 flattening
140 step
200 tangential contact area between chamfer 72 and the contact area of the screw head
201 protrusion
202 tangential contact region between planar extension 74 and the contact area of the screw head

1-12. (canceled)

13. A clamping connection, comprising:
a hollow shaft region including an axial slot and a flattening;
a shaft at least partially arranged in the hollow shaft region;
a screw having a screw thread and a screw head, at least partially resting against the flattening, and being offset from the shaft; and
a clamping ring.

14. The clamping connection according to claim 13, wherein the screw is arranged as a clamping screw.

15. The clamping connection according to claim 13, wherein the axial slot radially extends through the hollow shaft region.

16. The clamping connection according to claim 13, wherein the screw head has a larger diameter than a largest diameter of the screw thread.

17. The clamping connection according to claim 13, wherein the flattening includes a region having a reduced radial wall thickness in comparison with a radial wall thickness outside of the region.

18. The clamping connection according to claim 13, wherein the flattening includes a region having a reduced outer radius in comparison with a wall thickness outside of the region.

19. The clamping connection according to claim 13, wherein the screw thread at least partially rests against the flattening.

20. The clamping connection according to claim 13, wherein the screw is offset from an outer surface of the shaft.

21. The clamping connection according to claim 13, wherein an axis of the screw is offset from an axis of the shaft and the axis of the screw is arranged orthogonal to an axis of the shaft without intersection.

22. The clamping connection according to claim 13, further comprising a set screw adapted to axially lock the clamping ring on the hollow shaft region, the set screw being arranged in a radially directed threaded bore, a region covered by the flattening in a circumferential direction including and/or at least overlapping a circumferential angle region covered by the axial slot, an axial region covered by the axial slot including and/or at least overlapping an axial region covered by the flattening, an axial extension of a largest radial clearance of the clamping ring having a constant region adjoined on both sides by a rounded region on whose side facing away from the constant region a linear region follows.

23. The clamping connection according to claim 22, wherein the rounded region includes a circular segment.

24. The clamping connection according to claim 22, wherein the linear region includes a region in which a largest radial clearance extends proportionally to an axial position.

25. The clamping connection according to claim 13, further comprising a set screw adapted to axially lock the clamping ring on the hollow shaft region, the set screw being arranged in a radially directed threaded bore.

26. The clamping connection according to claim 13, wherein a region covered by the flattening in a circumferential direction includes and/or at least overlaps with a circumferential region covered by the axial slot.

27. The clamping connection according to claim 26, wherein an axial region covered by the axial slot includes and/or at least overlaps with an axial region covered by the flattening.

28. The clamping connection according to claim 13, wherein a recess is arranged on the clamping ring and is set apart from a set screw and from the screw in a circumferential direction.

29. The clamping connection according to claim 28, wherein the recess is adapted to balance the clamping connection.

30. The clamping connection according to claim 13, wherein the screw head rests against a contact area of the clamping ring, a radial outer contour and/or a radially outer edge of the clamping ring touching the contact area in a linear manner and/or at least at multiple points.

31. The clamping connection according to claim 13, wherein the screw head rests against a contact area of the clamping ring, an axial extension of a greatest radial clearance of the clamping ring touching an extension of a largest radial clearance of the contact area in a linear manner and/or at least at multiple axial positions.

32. The clamping connection according to claim 13, wherein an axial extension of a largest radial clearance of the clamping ring has a constant region which is adjoined on both sides by a rounded region on whose side facing away from the constant region a linear region follows.

33. The clamping connection according to claim 13, wherein the clamping ring includes a body of revolution having a radially outer surface predefined by an axial extension of a largest radial clearance, the body of revolution having recesses.

34. The clamping connection according to claim 30, wherein the clamping ring includes a radially and axially uninterrupted slot, the screw thread being at least partially screwed into a threaded bore situated on a side of the slot of the clamping ring facing away from the contact area.

35. A clamping connection, comprising:
a hollow shaft region including an axial slot and a flattening, the hollow shaft region adapted to receive at least a portion of a shaft;
a screw having a screw thread and a screw head, at least partially resting against the flattening, and being offset from the shaft; and
a clamping ring.

36. A drive, comprising:
a clamping connection as recited in claim 13;
wherein the shaft is arranged a rotor shaft of an electric motor, and the hollow-shaft section is connected in a torsionally fixed manner to an inputting toothed part of a gear unit driven by the electric motor.
